(19) United States
(12) Patent Application Publication
(10) Pub. No.: US 2021/0007337 A1
(43) Pub. Date: Jan. 14, 2021

(54) STRETCHABLE SCOOP NET

(71) Applicant: NINGBO DONGCHUAN SWIMMING POOL EQUIPMENT CO., LTD., Ningbo City (CN)

(72) Inventors: Huaizhong HE, Ningbo City (CN); Hu ZHANG, Ningbo City (CN)

(21) Appl. No.: 16/726,064

(22) Filed: Dec. 23, 2019

(30) Foreign Application Priority Data
Jul. 11, 2019 (CN) 201921086273.7

(51) Int. Cl. A01K 77/00

(52) U.S. Cl. CPC A01K 77/00

(57) ABSTRACT

A stretchable scoop net includes a frame, a handle, and a lock sleeve, wherein the annular or encircling frame is provided with a tubular installation part formed with external pin holes and guide cavities; the handle penetrates through the installation part and is able to axially move into the frame along the installation part; and the lock sleeve is arranged in the handle and is provided with elastic lock pins which enter the installation part via the guide cavities when the handle moves out of the frame and stretch into the external pin holes after the handle is rotated.

### BACKGROUND OF THE INVENTION

### Technical Field

The invention relates to the technical field of fishing devices, in particular to a stretchable scoop net.

### Description of Related Art

Scoop nets, also known as plain nets, are typically used for clearing away various things such as rubbish, shrimp, and sludge on the surface and bottom of water.

Most plain nets in the prior art have a large structural size and occupy a large space, thereby being inconvenient to store or package. Therefore, there is a demand for a stretchable scoop net which can be packaged or stored conveniently.

There have certain nets having a stretchable handle nowadays. For instance, a US Patent Publication No. U.S. Pat. No. 7,624,530 discloses a fishing net which comprises a hoop, a handle, and a flexible shaft, wherein the hoop has a net defining a fishing area and is provided with a row of lighting components, and a support is connected with a first end and a second end of a ring and defines a passage between the first end and the second end of the ring; the handle is connected to the support and can move along the passage to be used or stored, a lantern is connected to a far end of the handle with respect to the hoop and can move to retract, stretch, or deflect with respect to the handle; the flexible shaft is provided with a light component and can move to retreat into the handle or extend out of the handle close to the hoop to lighten a specific area.

Although the above-mentioned fishing net is stretchable, the handle cannot be locked as actually needed, and thus, the fishing net has yet to be improved.

### BRIEF SUMMARY OF THE INVENTION

The objective of the invention is to provide a stretchable scoop net to solve the above-mentioned problems in the prior art.

The objective of the invention is fulfilled through the following technical solution: a stretchable scoop net comprises:

An annular or encircling frame which is provided with a tubular installation part formed with external pin holes and guide cavities;

A handle which penetrates through the installation part and is able to axially move into the frame along the installation part; and

A lock sleeve arranged in the handle and provided with elastic lock pins which enter the installation part via the guide cavities when the handle moves out of the frame and stretch into the external pin holes after the handle is rotated.

Preferably, the handle is stretchable and includes a first tube penetrating through the installation part and a second tube penetrating through the first tube.

Preferably, a through hole is formed in the installation part and is communicated with the external pin holes, the first tube penetrates through the through hole and is formed with internal pin holes, the lock sleeve is arranged in the first tube, the elastic lock pins penetrate through the internal pin holes, and the first tube is fixedly connected with the installation part when the elastic lock pins penetrate through the external pin holes.

Preferably, the lock sleeve includes a tubular plug formed with a groove, and an elastic sheet is arranged in the groove and has one end integrally connected with the tubular plug and the other end provided with the elastic lock pins.

Preferably, the lock sleeve further includes an end cover which is connected with the end of the plug, the end cover is larger than the through hole and restrains the first tube in the installation part, and when the end cover is in abutted connection with the installation part, the elastic lock pins and the external pin holes are located at the same altitude.

Preferably, the guide cavities are outwards swelled bar-type cavities protruding outwards and are formed in the axial direction of the through hole.

Preferably, the number of the elastic lock pins is two, and the two elastic lock pins respectively penetrate through two sides of the first tube.

Preferably, the number of the guide cavities and the external pin holes is two, the two guide cavities and the two external pin holes respectively correspond to the two elastic lock pins, the two guide cavities are respectively located in the left side and the right side of the installation part, and the two external pin holes are respectively located in the front side and the rear side of the installation part.

Preferably, the frame further includes a border which has a rear end integrally connected with the installation part, and the handle is able to axially move to the front end of the border from the inside of the installation part.

Preferably, upper end faces of the elastic lock pins are inclined planes.

Compared with the prior art, the invention has the following beneficial effects:

1. The handle can retract into the frame, so that the size during storage is effectively reduced, and operation is convenient; and the handle can be rotated to be locked to the frame.

2. The first tube cannot be locked through the elastic lock pins via the external pin holes when moving axially, so that the maximum movement distance of the first tube is limited to prevent the first tube from disengaging from the installation part; the end cover not only has a limiting effect, but also has a positioning effect; and when the end cover abuts against the installation part, the elastic lock pins and the external pin holes are located at the same altitude, and at this moment, the elastic lock pins can enter the external pin holes through the rotation of the first tube.

3. The guide cavities are not located on the same line as the external pin holes, so that the first tube needs to rotate by an angle to rotate the elastic lock pins into the external pin holes; and in specific operation, the guide cavities are located on two sides, so that the first tube needs to rotate by 90° to make the elastic lock pins enter the external pin holes.

### BRIEF DESCRIPTION OF THE SEVERAL VIEWS OF THE DRAWINGS

FIG. 1 is a structural view of a stretchable scoop net in a packaged state;

FIG. 2 is a structural view of the stretchable scoop net in use;

FIG. 3 is a structural view of a lock sleeve of the invention;

FIG. 4 is a location diagram of elastic lock pins of the invention;

FIG. 5 is a structural view of an installation part of the invention.

Reference Signs: 100, frame; 110, border; 120, installation part; 121, through hole; 122, external pin hole; 123, guide cavity; 200, handle; 210, first tube; 211, internal pin hole; 220, second tube; 300, lock sleeve; 310, elastic lock pin; 320, plug; 330, end cover; 340, elastic sheet.

### DETAILED DESCRIPTION OF THE INVENTION

The technical solution of the invention is further expounded below in combination with the specific embodiments and accompanying drawings, and the invention is not limited to the following embodiments.

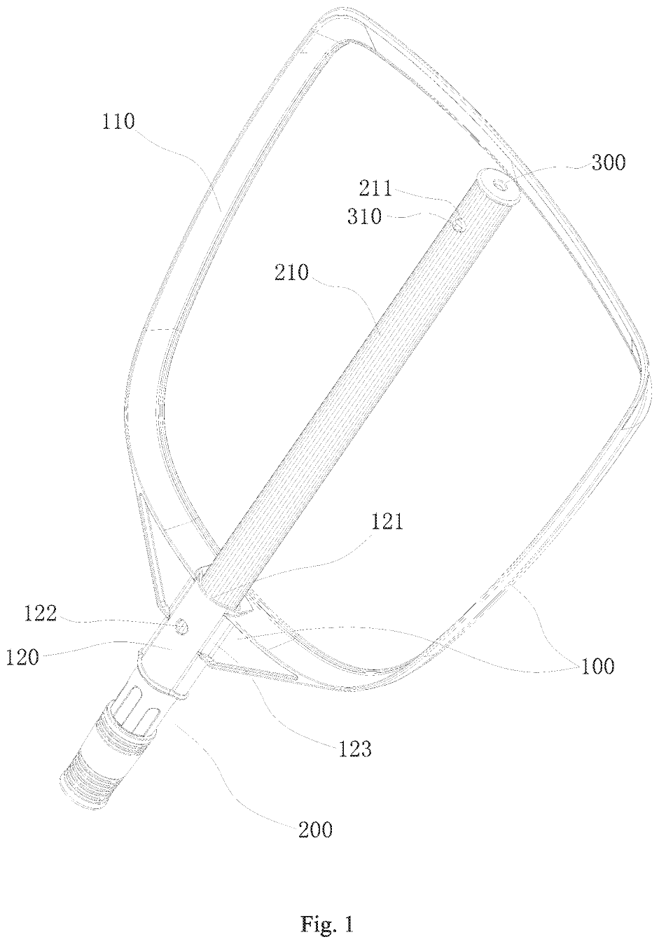

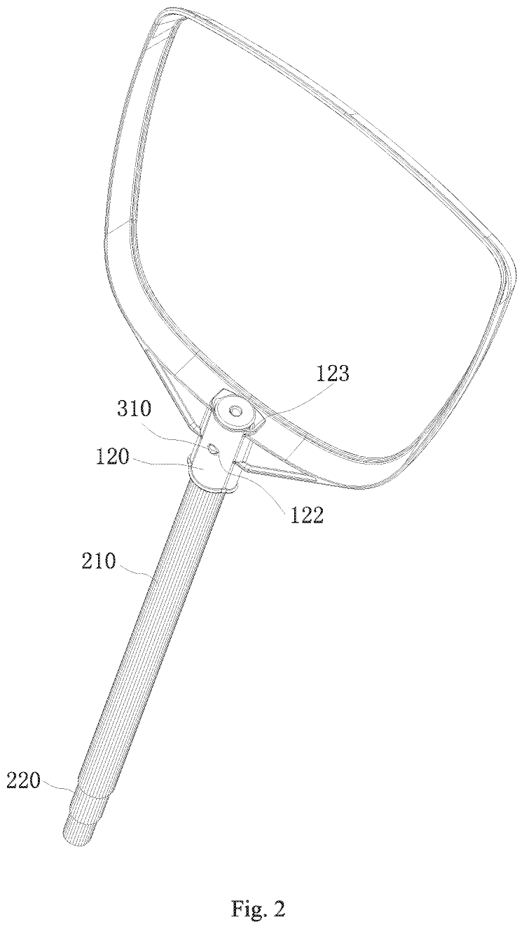

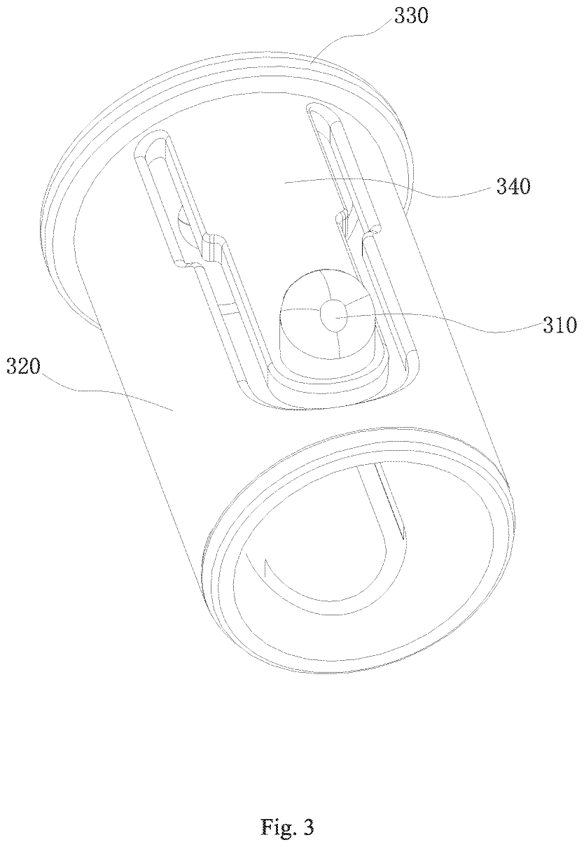

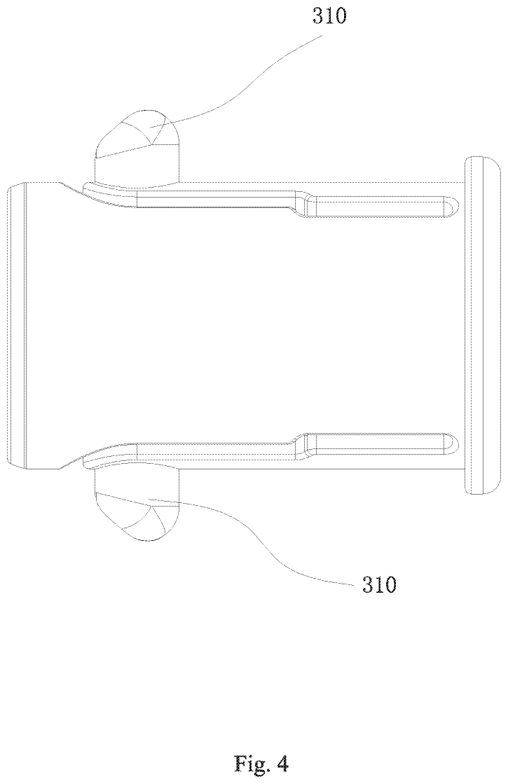

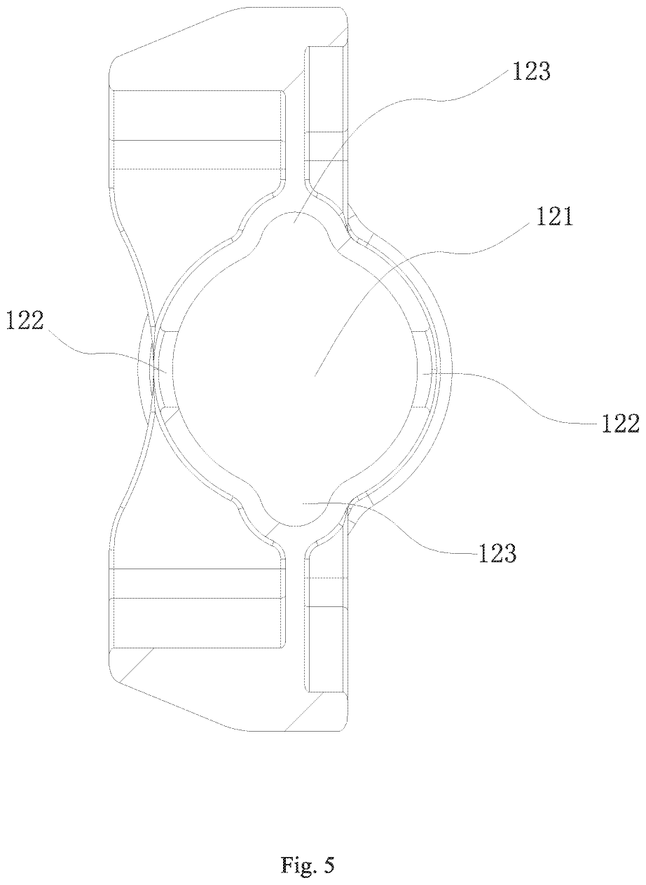

As shown in FIG. 1, FIG. 2, FIG. 3, FIG. 4, and FIG. 5, a stretchable scoop net comprises a frame 100, a handle 200, and a lock sleeve 300. The handle 200 can penetrate through the frame 100, so that the scoop net has a smaller size and can be packaged or stored conveniently. It should be noted that the handle 200 of the stretchable scoop net can be locked only if being rotated when drawn out of the frame 100 to be used and cannot be locked when moving axially.

Most existing scoop nets cannot retract to reduce the size. There may be some scoop nets that have stretchable handles 200 and can be packaged and stored after the handles 200 are shortened. However, such scoop nets still have a large size. Besides, existing fishing nets having handles 200 capable of penetrating through frames 100 cannot be locked controllably, in short, pins will naturally penetrate into holes after the handles 200 are drawn out, so that the handles 200 are locked to net borders. However, in the actual application, users have no intention to lock the handles 200 to the frames 100, it is necessary to leave the handles 200 and the frames 100 movable, and consequentially, the fishing nets are inconvenient to use.

Preferably, the frame 100 is actually used for installing a net bag and is square or annular, in a word, the frame 100 is an annular or encircling structure; and the frame 100 is provided with a tubular installation part 120 which is actually a tubular structure located at the rear end of the frame 100 and is connected with the handle 200, external pin holes 122 and guide cavities 123 are formed in the installation part 120, and the external pin holes 122 are not located on the same line as the guide cavities 123, so that the handle 200 will not be directly locked when moving axially.

The handle 200 penetrates through the installation part 120 and is able to move into the frame 100 along the installation part 120. It should be noted that the handle 200 is actually able to move into the frame 100 along the installation part 120 to be located in the frame 100, so that the package size of the scoop net is greatly reduced, and the whole scoop net only has the frame 100 structure reserved after being folded, thus being convenient to package and store.

A lock sleeve 300 is arranged in the upper end of the handle 200 and is provided with elastic lock pins 310 which enter the installation part 120 via the guide cavities 123 and stretch into the external pin holes 122 after the handle 200 is rotated.

Preferably, the lock sleeve 300 is actually used for locking the handle 200 to the installation part 120, and the handle 200 is prevented by the elastic lock pins 310 from moving and cannot be pushed into the frame 100 until the elastic lock pins 310 are pressed to unlock the handle 200.

It should be noted that the handle 200 is arranged on the installation part 120 and is able to move towards the frame 100, in the case, the handle 200 is stretchable and can move axially, the elastic lock pins 310 enter the installation part 120 via the guide cavities 123, the handle 200 moves along the guide cavities 123, and the external pin holes 122 are not located on the moving tracks of the elastic lock pins 310, so that the handle 200 will not be locked; the handle 200 can be locked only if being rotated to make the elastic lock pins 310 leave from the guide cavities 123 to enter the external pin holes 122. Furthermore, the handle 200 can be locked to unfold the scoop net only if being rotated. Compared with existing folding fishing nets, an extra operation needs to be performed to lock the handle of the scoop net of the invention, so that the locking reliability is guaranteed.

As shown in FIG. 1, FIG. 2, and FIG. 3, based on the above embodiments, the handle 200 is stretchable and includes a first tube 210 penetrating through the installation part 120 and a second tube 220 penetrating through the first tube 210.

Preferably, the handle 200 is stretchable, that is, the second tube 220 is able to stretch into the first tube 210, so that the length of whole the handle 200 can be decreased to the length of the first tube 210; and the first tube 210 is able to stretch into the frame 100 through the installation part 120, so that the size of the scoop net is further reduced.

Preferably, the handle 200 at least includes the first tube 210 and the second tube 220 and can further include a third tube or a fourth tube, wherein each tube can stretch into the tube in front, so that the size of the handle 200 is reduced; and the number of tubes of the handle 200 can be adjusted as actually needed.

As shown in FIG. 1, FIG. 2, FIG. 3, and FIG. 5, based on the above embodiments, a through hole 121 is formed in the installation part 120 and is communicated with the external pin holes 122, the first tube 210 penetrates through the through hole 121 and is formed with internal pin holes 211, the lock sleeve 300 is arranged in the first tube 210, the elastic lock pins 310 penetrate through the internal pin holes 211, and the first tube 210 is fixedly connected with the installation part 120 when the elastic lock pins 310 penetrate through the external pin holes 122.

Preferably, the through hole 121 and the external pin holes 122 communicated with the through hole 121 are formed in the tubular installation part 120, the first tube 210 penetrates through the through hole 121 and is formed with the internal pin holes 211, and the internal pin holes 211 coincide with the external pin holes 122, so that the elastic lock pins 310 penetrate through the internal pin holes 211 and the external pin holes 122 to fix the first tube 210 in the through hole 121, and accordingly, the first tube 210 is prevented from moving.

Preferably, such positioning manner based on the pin holes and the pins fulfills an ingenious structure and a great convenience for unlocking because the first tube 210 is able to move into the frame 100 as long as the elastic lock pins 310 are pressed to disengage from the external pin holes 122.

As shown in FIG. 1, FIG. 3, FIG. 4, and FIG. 5, based on the above embodiments, the lock sleeve 300 includes a tubular plug 320 formed with a groove, and an elastic sheet 340 is arranged in the groove and has one end integrally connected with the tubular plug and the other end provided with the elastic lock pins 310.

Preferably, the lock sleeve 300 is provided with the plug 320 which penetrates through the upper end of the first tube 210 and formed with the groove, one end of the elastic sheet 340 is connected with the plug 320, and the elastic sheet 340 is located in the groove, so that the elastic sheet 340 can be pressed, and accordingly, the elastic lock pins 310 can disengage from the external pin holes 122.

Preferably, the elastic sheet 340 can be structurally regarded as a non-closed Ω-shaped groove formed in the plug 320 actually, and the elastic sheet 340 formed on the plug 320 can be pressed or rebounded, so that the first tube 210 is locked or unlocked.

As shown in FIG. 1, FIG. 3, and FIG. 4, the lock sleeve 300 further includes an end cover 330 which is connected with the end part of the plug 320, and the end cover 330 is larger than the through hole 121 and restrains the first tube 210 in the installation part 120, and when the end cover 330 is in abutted connection with the installation part 120, the elastic lock pins 310 and the external pin holes 122 are located at the same altitude.

Preferably, the end cover 330 is arranged at the upper end of the lock sleeve 300 and covers the upper part of the plug 320, and the end cover 330 has a limit effect; the size of the end cover 330 is greater than that of the through hole 121, so that the first tube 210 can axially move to a part, abutting against the installation part 120, of the end cover 330 and cannot be drawn out of the through hole 121. It should be noted that the first tube 210 cannot be locked through the elastic lock pins 310 and the external pin holes 122 when moving axially, so that the end cover 330 is arranged to limit the maximum movement distance of the first tube 210 to prevent the first tube 210 from disengaging from the installation part 120.

Preferably, the end cover 330 not only has a limiting effect, but also has a positioning effect. During actual operation, the first tube 210 moves into the frame 100 via the through hole 121 to be retracted and is drawn out of the frame 100 to be used; the first tube 210 can rotate in the through hole 121, and if the first tube 210 does not move to an appropriate position, the elastic lock pins 310 cannot be aligned to the external pin holes 122 after rotation, and consequentially, locking is inconvenient; and the end cover 330 can fulfill the positioning effect before the locking, that is, when the end cover 330 abuts against the installation part 120, the elastic lock pins 310 and the external pin holes 122 are located at the same altitude, and at this moment, the elastic lock pins 310 can enter the external pin holes 122 through the rotation of the first tube 210.

As shown in FIG. 1, FIG. 2, and FIG. 5, based on the above embodiments, the guide cavities 123 are bar-type cavities which protrude outwards and are formed in the axial direction of the through hole 121.

Preferably, the guide cavities 123 are formed in the axial direction of the through hole 121 and protrude radially (outwards). The elastic lock pins 310 are convex, cannot directly enter the through hole 121, and can enter the through hole 121 under the guidance of the guide cavities 123, that is, the elastic lock pins 310 enter the guide cavities 123 first, so that the first tube 210 can continue to move out of a border 110.

Because the guide cavities 123 are not located on the same line as the external pin holes 122, the first tube 210 needs to rotate by an angle to rotate the elastic lock pins 310 into the external pin holes 122; and in specific operation, the guide cavities 123 are located on two sides, so that the first tube 210 needs to rotate by 90° to make the elastic lock pins 310 enter the external pin holes 122.

As shown in FIG. 3, FIG. 4, and FIG. 5, based on the above embodiments, the number of the elastic lock pins 310 is two, and the two elastic lock pins 310 respectively penetrate through two sides of the first tube 210.

Preferably, two internal pin holes 211 are actually formed in the ends of the first tube 210, and the two elastic lock pins 310 penetrate through the two internal pin holes 211 to lock the installation part 120 and the first tube 210 more reliably and to fulfill a more uniform locking force.

As shown in FIG. 3, FIG. 4, and FIG. 5, the number of the guide cavities 123 and the external pin holes 122 is two, the two guide cavities 123 and the two external pin holes 122 respectively correspond to the two elastic lock pins 310, the two guide cavities 123 are respectively located in the left side and the right side of the installation part 120, and the two external pin holes 122 are respectively located in the front side and the rear side of the installation part 120.

Preferably, the number of the guide cavities 123 and the external pin holes 122 is one or two; on the basis that the number of the elastic lock pins 310 is two, the number of the guide cavities 123 and the external pin holes 122 is specially set to two; and when the installation part 120 is vertical, the two guide cavities 123 are arranged in the left side and the right side of the installation part 120, and the external pin holes 122 are located in the front side and the rear side of the installation part 120, so that the guide cavities 123 are not located on the same line as the external pin holes 122; and during locking, the elastic lock pins 310 can be driven into the external pin holes 122 as long as the first tube 210 is rotated by 90°.

As shown in FIG. 1 and FIG. 2, based on the above embodiments, the frame 100 further includes the border 110 which has a rear end integrally connected with the installation part 120, and the handle 200 is able to axially move to the front end of the border 110 from the inside of the installation part 120.

Preferably, the frame 100 includes the installation part 120 and the border 110 integrally connected with the installation part 120, wherein a net bag is arranged at the periphery of the border 110, and the first tube 210 penetrates through the border 110, so that the size of scoop net is reduced.

As shown in FIG. 3 and FIG. 4, based on the above embodiments, upper end faces of the elastic lock pins 310 are inclined planes.

It should be noted that the sides, close to the installation part 120, of the elastic lock pins 310 are low, and the sides, close to the frame 100, of the elastic lock pins 310 are high, and the inclined planes formed in this way make the elastic lock pins 310 stretch more conveniently and be locked more stably and reliably. Particularly, the upper end faces of the elastic lock pins 310 are inclined planes, so that the elastic lock pins 310 can be easily pressed via the guide cavities 123 when entering the guide cavities 123 and are unlikely to disengage from the external pin holes 122 when located in the external pin holes 122.

The specific embodiments described herein are only used for illustratively explaining the spirit of the invention. Various modifications, supplements, or similar substitutions of these specific embodiments can be made by those skilled in the art without deviating from the spirit of the invention or going beyond the scope defined by the appended claims of the invention.

1. A stretchable scoop net comprising:
an annular or encircling frame which is provided with a tubular installation part formed with external pin holes and guide cavities;
a handle which penetrates through the installation part and is able to axially move into the frame along the installation part; and
a lock sleeve arranged in the handle and provided with elastic lock pins which enter the installation part via the guide cavities when the handle moves out of the frame and stretch into the external pin holes after the handle is rotated.

2. The stretchable scoop net according to claim 1, wherein the handle is stretchable and includes a first tube penetrating through the installation part and a second tube penetrating through the first tube.

3. The stretchable scoop net according to claim 2, wherein a through hole is formed in the installation part and is communicated with the external pin holes, the first tube penetrates through the through hole and is formed with internal pin holes, the lock sleeve is arranged in the first tube, the elastic lock pins penetrate through the internal pin holes, and the first tube is fixedly connected with the installation part when the elastic lock pins penetrate through the external pin holes.

4. The stretchable scoop net according to claim 3, wherein the lock sleeve includes a tubular plug formed with a groove, and an elastic sheet is arranged in the groove and has an end integrally connected with the tubular plug and an end provided with the elastic lock pins.

5. The stretchable scoop net according to claim 4, wherein the lock sleeve further includes an end cover which is connected with an end of the plug, the end cover is larger than the through hole and restrains the first tube in the installation part, and when the end cover is in abutted connection with the installation part, the elastic lock pins and the external pin holes are located at a same altitude.

6. The stretchable scoop net according to claim 3, wherein the guide cavities are bar-type cavities protruding outwards and are formed in an axial direction of the through hole.

7. The stretchable scoop net according to claim 6, wherein the number of the elastic lock pins is two, and the two elastic lock pins respectively penetrate through two sides of the first tube.

8. The stretchable scoop net according to claim 7, wherein the number of the guide cavities and the external pin holes is two, the two guide cavities and the two external pin holes respectively correspond to the two elastic lock pins, the two guide cavities are respectively located in a left side and a right side of the installation part, and the two external pin holes are respectively located in a front side and a rear side of the installation part.

9. The stretchable scoop net according to claim 1, wherein the frame further includes a border which has a rear end integrally connected with the installation part, and the handle is able to axially move to a front end of the border from an inside of the installation part.

10. The stretchable scoop net according to claim 7, wherein upper end faces of the elastic lock pins are inclined planes.
